(19) United States
(12) Patent Application Publication
(10) Pub. No.: US 2013/0188732 A1
(43) Pub. Date: Jul. 25, 2013

(54) Multi-Threaded Texture Decoding

(71) Applicants: Bo Zhou, San Diego, CA (US); Shu Xiao, San Diego, CA (US); Junchen Du, San Diego, CA (US); Suhail Jalil, Poway, CA (US)

(72) Inventors: Bo Zhou, San Diego, CA (US); Shu Xiao, San Diego, CA (US); Junchen Du, San Diego, CA (US); Suhail Jalil, Poway, CA (US)

(73) Assignee: QUALCOMM INCORPORATED, San Diego, CA (US)

(21) Appl. No.: 13/354,364

(22) Filed: Jan. 20, 2012

(51) Int. Cl. H04N 7/26

(52) U.S. Cl. 375/240.24; 375/E07.027; 375/E07.176

(57) ABSTRACT

A method for performing texture decoding in a multi-threaded processor includes substantially simultaneously decoding, in multiple hardware threads, at least two macro-blocks of a VP8 frame. Each hardware thread decodes one macro-block at a time. The method may also include assigning a macro-block from the at least two macro-blocks of the VP8 frame to a hardware thread of the multi-threaded processor.

### BACKGROUND

1. Field

The present disclosure relates, in general, to data processing systems and, more specifically, to multi-threaded texture decoding.

2. Background

VP8 is an open source video compression format supported by a consortium of technology companies. In particular, VP8 is the video compression format used by WebM files. WebM is a new open media project that is dedicated to developing a high-quality, open media format for the World Wide Web. The VP8 format was originally developed by On2 Technologies, Inc. as a successor to the VPx family of video compression/decompression tools. The VP8 format has gained industry support by achieving high compression efficiency, with low computational complexity for decoding VP8 compressed video streams.

### SUMMARY

According to one aspect of the present disclosure, a method for performing texture decoding in a multi-threaded processor is described. The method includes substantially simultaneously decoding, in multiple hardware threads, at least two macro-blocks of a VP8 frame. Each hardware thread processes one macro-block at a time. The method may also include assigning a macro-block of the VP8 frame to each hardware thread of the multi-threaded processor.

In another aspect, an apparatus for performing multi-threaded texture decoding is described. The apparatus includes at least one multi-threaded processor and a memory coupled to the at least one multi-threaded processor. The multi-threaded processor(s) is configured to substantially simultaneously decode, in multiple hardware threads, at least two macro-blocks of a VP8 frame. Each hardware thread decodes one thread at a time. The apparatus may also include a controller that assigns a macro-block of the VP8 frame to each hardware thread of a multi-threaded processor.

In a further aspect, a computer program product for performing multi-threaded texture decoding is described. The computer program product includes a non-transitory computer-readable medium having program code recorded thereon. The computer program product has program code to substantially simultaneously decode, in multiple hardware threads, at least two macro-blocks of a VP8 frame Each hardware thread processes one macro-block at a time. The computer program product may also includes program code to assign a macro-block of the VP8 frame to a hardware thread of a multi-threaded processor.

In another aspect, an apparatus for multi-threaded texture decoding is described. The apparatus includes means for assigning a macro-block of at least two macro-blocks of a VP8 frame to a hardware thread. Each hardware thread processes a macro-block, one at a time. The apparatus also includes means for substantially simultaneously decoding, in multiple hardware threads, the macro-blocks of the VP8 frame.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram of a multi-processor system including texture decoding logic, according to one aspect of the disclosure.

FIG. 2 is a block diagram illustrating the texture decoding logic of FIG. 1 according to a further aspect of the disclosure.

FIG. 3 is a block diagram illustrating parallel texture decoding of a macro-block from a frame according to a further aspect of the disclosure.

FIG. 4 illustrates a method for multi-threaded texture decoding according to an aspect of the disclosure.

FIG. 5 is a block diagram illustrating aspects of a wireless device including a processor operable to execute instructions for multi-threaded texture decoding according to a further aspect of the disclosure.

FIG. 6 is a block diagram showing a wireless communication system in which an aspect of the disclosure may be advantageously employed.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form to avoid obscuring such concepts.

Decoding video streams encoded according to a VP8 format is generally performed with a single thread to perform prediction, discrete cosine transform (DCT)/Walsh-Hadamard transform (WHT) inversion, and reconstruction in raster-scan order. In particular, VP8 specifications generally prohibit macro-block filtering until each of the macro-blocks of a frame is reconstructed. That is, VP8 decoding is specified as occurring based on frame boundaries. The single-thread processing specified for texture decoding of VP8 format encoded streams prevents multi-threaded processors as well as multi-processors from achieving high performance during VP8 decoding. According to one aspect of the disclosure, at least two macro-blocks (MBs) of a VP8frame are decoded in parallel (simultaneously), one in each hardware thread. Parallel decoding of VP8 encoded macro-blocks may improve cache efficiency.

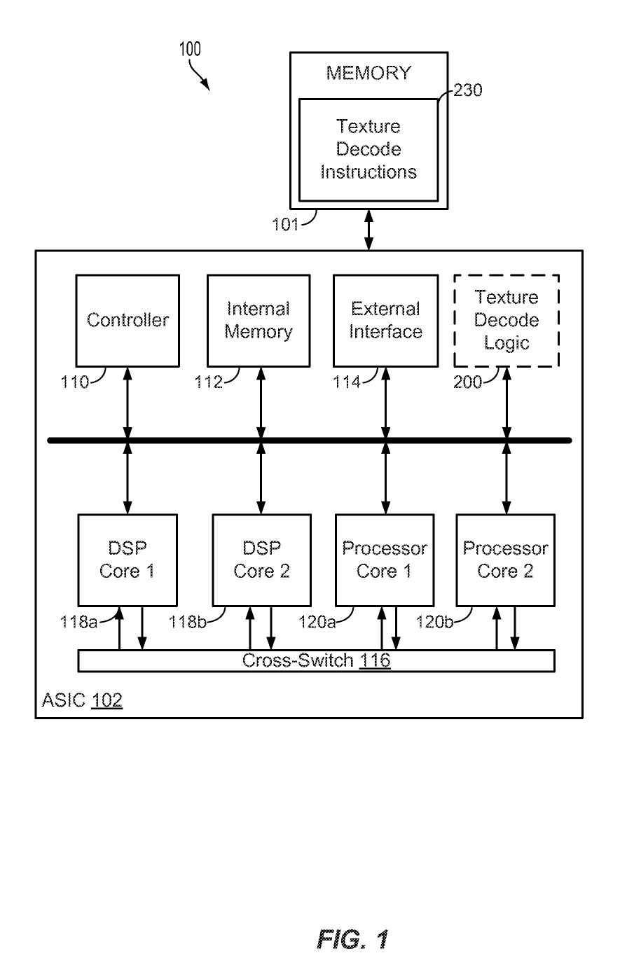

FIG. 1 shows a block diagram of a multi-processor system 100, including texture decode logic 200 according to one aspect of the disclosure. An application specific integrated circuit (ASIC) 102 includes various processing units that support multi-threaded texture decoding. For the configuration shown in FIG. 1, the ASIC 102 includes DSP cores 118A and 118B, processor cores 120A and 120B, a cross-switch 116, a controller 110, an internal memory 112, and an external interface unit 114. DSP cores 118A and 118B, and processor cores 120A and 120B support various functions such as video, audio, graphics, gaming, and the like. Each processor core may be a RISC (reduced instruction set computing) machine, a microprocessor, or some other type of processor. The controller 110 controls the operation of the processing units within the ASIC 102. Internal memory 112 stores data and program codes used by the processing units within the ASIC 102. The external interface unit 114 interfaces with other units external to the ASIC 102. In general, the ASIC 102 may include fewer, more and/or different processing units than those shown in FIG. 1. The number of processing units and the types of processing units included in the ASIC 102 are dependent on various factors such as the communication systems, applications, and functions supported by the multi-processor system 100.

The texture coding techniques may be implemented by various means. For example, these techniques may be implemented in hardware, firmware, software, or a combination thereof. For a hardware implementation, the texture coding techniques may be implemented within one or more ASICs, DSPs, DSPDs, PLDs, FPGAs, processors, controllers, micro-controllers, microprocessors, electronic devices, other electronic units designed to perform the functions described herein, or a combination thereof. Certain aspects of the texture coding techniques may be implemented with software modules (e.g., procedures, functions, and so on) that perform the functions described. The software codes may be stored in a memory (e.g., the memory 101 and/or 112 in FIG. 1) and executed by a processor (e.g., DSP cores 118A and/or 118B). The memory may be implemented within the processor or external to the processor.

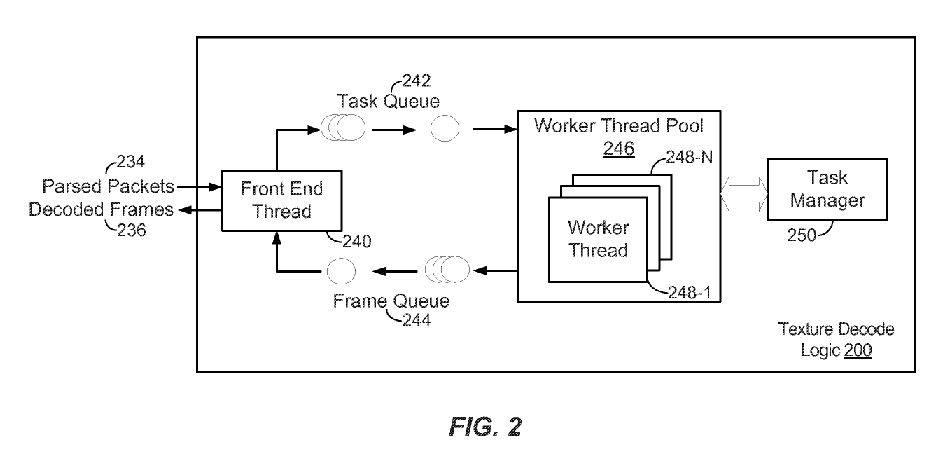

The ASIC 102 further couples to a memory 101 that stores texture decode instructions 230. For the configuration shown in FIG. 1, each processing core executes texture decode instructions 230. In one configuration, the ASIC 102 may include texture decode logic 200, as further illustrated in FIG. 2.

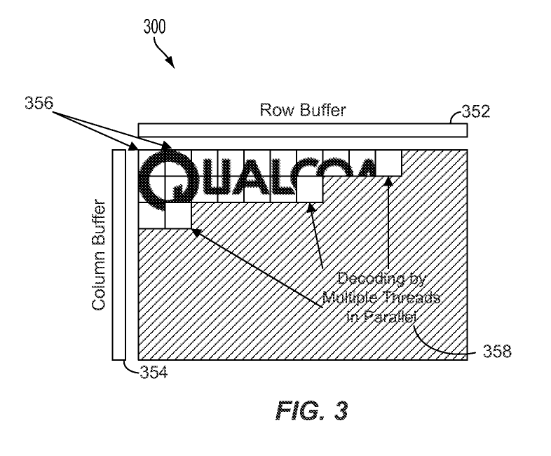

FIG. 2 is a block diagram illustrating the texture decode logic 200 of FIG. 1 according to one aspect of the disclosure. Representatively, parsed packets 234 are received by a front end thread 240. In this configuration, the front end thread 240 provides macro-blocks from the frames of the parsed packets 234 to a task queue 242. From the task queue 242, macro-blocks are assigned to worker threads 248 (248-1, . . . , 248-N) of a worker thread pool 246 according to a task size. In this configuration, each worker thread 248 performs complete texture decoding macro-block by macro-block. That is, each worker thread 248 performs prediction, inverse transformation, reconstruction, and loop filtering macro-block by macro-block. Accordingly, the worker threads 248 collectively perform parallel/simultaneous texture decoding of macro-blocks, for example, as shown in FIG. 3. In addition, each thread decodes a number of macro-blocks at a time according to task size.

As further illustrated in FIG. 2, a task manager 250 maintains the dependency between macro-blocks according to one aspect of the disclosure. In this aspect of the disclosure, the task manager 250 assigns tasks of one or more macro-blocks to worker threads 248 that have dependent neighbors which are decoded. Once a worker thread 248 completes decoding of a macro-block, the decoded macro-block may be stored in a frame queue 244. In this configuration, the front end thread 240 sends decoded frames 236 from the frame queue 244 to, for example, a frame buffer (not shown). In this configuration, each worker thread 248 may process two macro-blocks at a time; however, other task size configurations are possible.

FIG. 3 is a block diagram illustrating parallel decoding of macro-blocks 356 within a frame 300, according to one aspect of the disclosure. In this configuration, a row buffer 352 and a column buffer 354 are provided to enable loop-filtering of each macro-block 356 following reconstruction. In this configuration, the row buffer 352 and the column buffer 354 are introduced to eliminate the restriction against loop-filtering macro-blocks immediately following reconstruction. Representatively, the row buffer 352 and a column buffer 354 enable decoding by multiple threads in parallel 358. As noted above, conventionally, VP8 decoding specifies delaying loop-filtering of macro-blocks 356 until reconstruction of each macro-block 356 within a frame is complete.

As shown in the configuration of FIG. 3, the row buffer 352 and the column buffer 354 store reconstructed pixels before loop-filtering. In this aspect of the disclosure, the unfiltered pixels stored in the row buffer 352 and the column buffer 354 enable intra-frame prediction, which is performed using unfiltered pixels. In particular, intra-frame prediction is performed using the reconstructed neighbor information of previous macro-blocks. In this configuration, once the reconstructed pixel information of a macro-block 356 is stored in the row buffer 352 and the column buffer 354, the macro-block 356 is immediately filtered. That is, the reconstructed pixel information is stored within the row buffer 352 and the column buffer 354 to enable intra-frame prediction for a next macro-block. In this aspect of the disclosure, cache performance is improved by focusing texture decoding within local (line) buffers, while reducing or avoiding frame buffer access when possible.

Referring again to FIG. 2, the multi-thread scheme for texture decoding of VP8 format encoded data may achieve thirty frames per second (30 fps) for decoding 720 p video clips. In this configuration, there is no predefined decoding sequence for the macro-blocks within a frame. In particular, the individual worker threads 248 request tasks whenever any task is ready for decoding. As a result, more and more homogeneous threads start decoding as the decoding progresses for one frame. Therefore, the time in which the worker threads 248 are occupied with a task is increased and dynamically balanced, such that an overall amount of time for decoding one frame is significantly reduced. In this aspect of the disclosure, a task size is based on a cache line size. That is, the number of macro-blocks being decoded by a hardware thread is based on the cache line size. For example, a task size of two macro-blocks is selected for a thirty-two byte cache line size. In one aspect of the disclosure, a specific hardware thread may be assigned to each row of a frame.

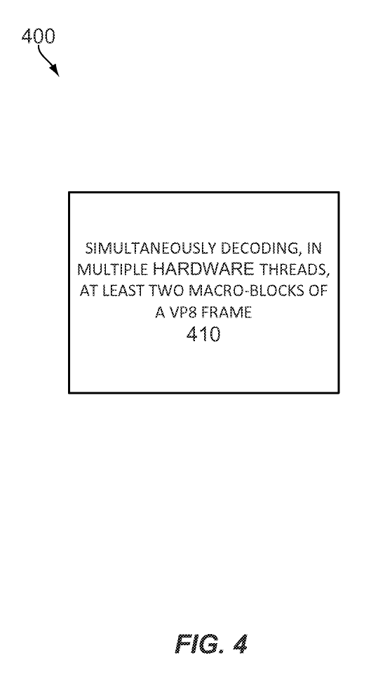

FIG. 4 illustrates a method 400 for multi-threaded texture decoding according to an aspect of the disclosure. At block 410, at least two macro-blocks (MBs) of a VP8 frame are simultaneously decoded, in multiple hardware threads, using an apparatus. Each hardware thread decodes one macro-block at a time. As described herein, simultaneous decoding of the at least two macro-blocks may refer to performing texture decoding of the at least two macro-blocks at, or substantially at, the same time. According to this aspect of the disclosure, each worker thread performs complete texture decoding (prediction, inverse transform, reconstruction, and loop-filtering) on a macro-block by macro-block.

For example, prediction of macro-block zero (MB0), inverse transform of MB0, reconstruction of MB0, and loop-filtering of MB0 are performed in one worker thread substantially simultaneously with prediction of macro-block one (MB1), inverse transform of MB1, reconstruction of MB1, and loop-filtering of MB1 in another worker thread. In this aspect of the disclosure, loop-filtering of a macro-block immediately follows reconstruction of the macro-block. Depending on the task size, each worker thread may process multiple macro-blocks, such that the hardware threads collectively process multiple macro-blocks in parallel.

In one configuration, the apparatus includes means for multi-threaded texture decoding in a processor including a logical circuit. In one aspect of the disclosure, the decoding means may be the texture decode logic 200, the DSP cores 118A, 118B, the processor cores 120A and 120B, and/or the multi-processor system 100 configured to perform the functions recited by the decoding means. In another aspect of the disclosure, the aforementioned means may be any module or any apparatus configured to perform the functions recited by the aforementioned means.

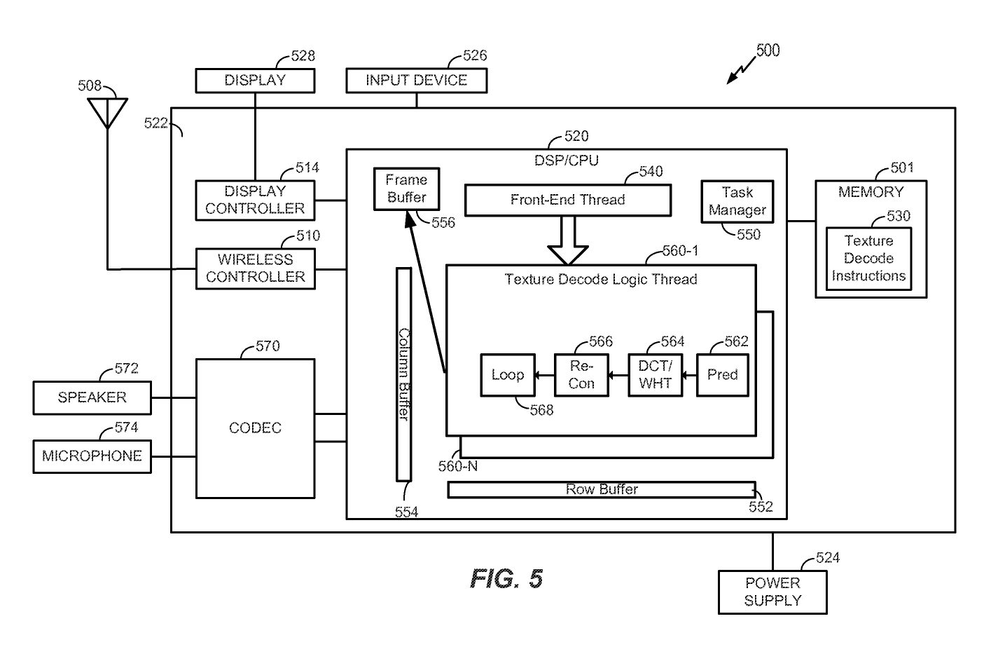

FIG. 5 illustrates a block diagram of a wireless device 500 configured for multi-threaded texture decoding according to one aspect of the disclosure. The wireless device 500 includes a processor, such as a digital signal processor (DSP) 520, coupled to a memory 501. In a particular aspect of the disclosure, the memory 501 stores and may transmit instructions executable by the DSP 520, such as the texture decode instructions 530. Upon execution of the texture decode instructions 530, multiple texture decode logic threads 560 (560-1, . . . , 560-N) are established for performing parallel texture decoding of multiple macro-blocks of a frame for each thread 560. Representatively, each texture decode logic thread includes a prediction block 562, a discrete cosine transform (DCT)/Walsh-Hadamard transform (WHT) inversion block 564, a reconstruction block 566, and a loop-filtering block 568. In this configuration, a macro-block is immediately provided from the reconstruction block 566 to the loop- filtering block 568 for enabling parallel texture decoding at a macro-block boundary rather than a conventional frame boundary.

Texture decoding at a macro-block level is performed by storing unfiltered pixels in the row buffer 552 and the column buffer 554, according to one aspect of the disclosure. Storing of the unfiltered pixels in the row buffer 552 and the column buffer 554 enables prediction for subsequent macro-blocks. As described with reference to FIG. 2, a task manager 550 assigns macro-blocks to the texture decode logic threads 560. In addition, a front-end thread 540 provides macro-blocks to the various threads 560 and stores decoded frames within a frame buffer 556. In this configuration, an amount of macro-blocks assigned to each thread 560 is based on a cache line size. For example, a task size of two macro-blocks for each thread 560 is selected for a thirty-two byte cache line size.

FIG. 5 also shows a display controller 514 that is coupled to the DSP 520 and to a display 528. A coder/decoder (CODEC) 570 (e.g., an audio and/or voice CODEC) can be coupled to the DSP 520. For example, the CODEC 570 may cause execution of texture decode instructions 530 as part of a decoding process. Other components, such as the display controller 514 (which may include a video CODEC and/or an image processor) and a wireless controller 510 (which may include a modem) may also cause execution of the texture decode instructions 530 during signal processing. A speaker 572 and a microphone 574 can be coupled to the CODEC 570. FIG. 5 also indicates that the wireless controller 510 can be coupled to a wireless antenna 508. In a configuration, the DSP 520, the display controller 514, the memory 501, the CODEC 570, and the wireless controller 510 are included in a system-in-package or system-on-chip device 522.

In a particular configuration, an input device 526 and a power supply 524 are coupled to the system-on-chip device 522. Moreover, in a particular configuration, as illustrated in FIG. 5, the display 528, the input device 526, the speaker 572, the microphone 574, the wireless antenna 508, and the power supply 524 are external to the system-on-chip device 522. Nevertheless, each of the display 528, the input device 526, the speaker 572, the microphone 574, the wireless antenna 508, and the power supply 524 can be coupled to a component of the system-on-chip device 522, such as an interface or a controller.

It should be noted that although FIG. 5 depicts a wireless communications device, the DSP 520 and the memory 501 may also be integrated into a set-top box, a music player, a video player, an entertainment unit, a navigation device, a personal digital assistant (PDA), a fixed location data unit, or a computer. A processor (e.g., the DSP 520 and/or a processor including the microprocessor 120 of FIG. 1) may also be integrated into such a device.

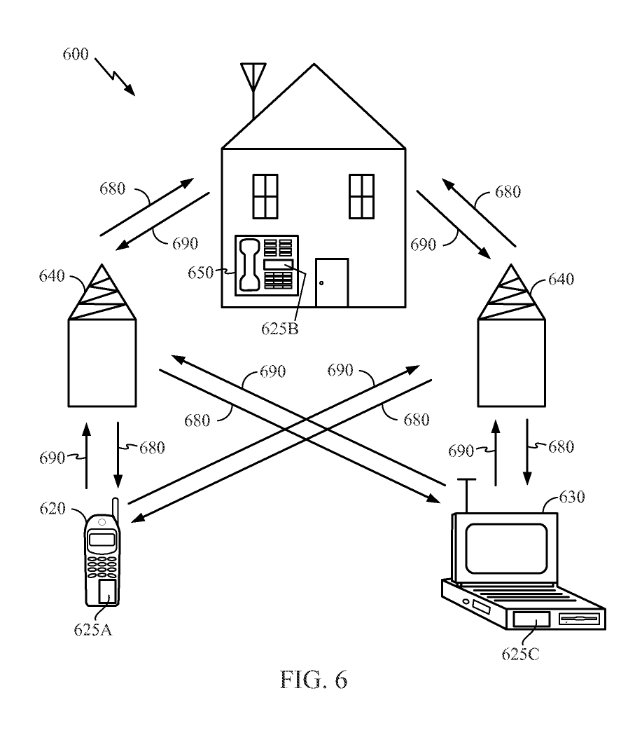

FIG. 6 is a block diagram showing an exemplary wireless communication system 600 in which an embodiment of the disclosure may be advantageously employed. For purposes of illustration, FIG. 6 shows three remote units 620, 630, and 650 and two base stations 640. It will be recognized that wireless communication systems may have many more remote units and base stations. Remote units 620, 630, and 650 include IC devices 625A, 625B, and 625C, that include the multi-threaded texture decoder. It will be recognized that any device containing an IC may also include a multi-threaded texture decoder disclosed here, including the base stations, switching devices, and network equipment. FIG. 6 shows forward link signals 680 from the base station 640 to the remote units 620, 630, and 650 and reverse link signals 690 from the remote units 620, 630, and 650 to base stations 640.

In FIG. 6, remote unit 620 is shown as a mobile telephone, remote unit 630 is shown as a portable computer, and remote unit 650 is shown as a fixed location remote unit in a wireless local loop system. For example, the remote units may be mobile phones, hand-held personal communication systems (PCS) units, portable data units such as personal data assistants, GPS enabled devices, navigation devices, set top boxes, music players, video players, entertainment units, fixed location data units such as meter reading equipment, or any other device that stores or retrieves data or computer instructions, or any combination thereof. Although FIG. 6 illustrates remote units according to the teachings of the disclosure, the disclosure is not limited to these exemplary illustrated units. Aspects of the present disclosure may be suitably employed in any device which includes a multi-threaded texture decoder.

Although specific circuitry has been set forth, it will be appreciated by those skilled in the art that not all of the disclosed circuitry is required to practice the disclosed embodiments. Moreover, certain well known circuits have not been described, to maintain focus on the disclosure.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for texture decoding in a multi-threaded processor, comprising:
substantially simultaneously decoding at least two macro-blocks of a VP8 frame, by a plurality of hardware threads, each hardware thread processing a macro-block.

2. The method of claim 1, in which the at least two macro-blocks are from different rows.

3. The method of claim 1, further comprising storing unfiltered pixels in at least one of a row buffer and a column buffer.

4. The method of claim 1, further comprising:
storing reconstructed pixels of the at least two macro-blocks within at least one of a row buffer and a column buffer.

5. The method of claim 1, in which decoding further comprising:
reconstructing one macro-block in each hardware thread; and then
filtering the reconstructed macro-block.

6. The method of claim 1, in which a number of macro-blocks being decoded by a single hardware thread is based on a cache line size.

7. The method of claim 1, in which decoding comprises simultaneously reconstructing and filtering each of the at least two macro-blocks.

8. The method of claim 1, in which decoding comprises simultaneously texture decoding each of the at least two macro-blocks of the VP8 frame.

9. The method of claim 1, further comprising integrating the multi-threaded processor into at least one of a mobile phone, a set top box, a music player, a video player, an entertainment unit, a navigation device, a computer, a hand-held personal communication systems (PCS) unit, a portable data unit, and a fixed location data unit.

10. An apparatus for multi-threaded texture decoding comprising:
a memory; and
at least one multi-threaded processor coupled to the memory, the at least one multi-thread processor being configured to substantially simultaneously decode at least two macro-blocks of a VP8 frame by a plurality of hardware threads, each hardware thread processing a macro-block.

11. The apparatus of claim 10, in which the at least two macro-blocks are from different rows.

12. The apparatus of claim 10, in which the at least one multi-threaded processor is further configured:
to store unfiltered pixels in at least one of a row buffer and a column buffer; and
to store reconstructed pixels of the at least two macro-blocks within at least one of the row buffer and the column buffer.

13. The apparatus of claim 10, in which the multi-threaded processor is further configured to decode by:
reconstructing one macro-block in a hardware thread; and then
filtering the reconstructed macro-block.

14. The apparatus of claim 10, further comprising a controller configured to assign a macro-block of at least two macro-blocks of the VP8 frame to a hardware thread of the multi-threaded processor.

15. The apparatus of claim 10, in which the multi-thread processor comprises one of a digital signal processor and a multi-core processor.

16. The apparatus of claim 10, in which a number of macro-blocks being decoded by a single hardware thread is based on a cache line size.

17. The apparatus of claim 10, integrated into at least one of a mobile phone, a set top box, a music player, a video player, an entertainment unit, a navigation device, a computer, a hand-held personal communication systems (PCS) unit, a portable data unit, and a fixed location data unit.

18. A apparatus for multi-threaded texture decoding, comprising:
means for assigning a macro-block of at least two macro-blocks of a VP8 frame to a hardware thread; and
means for substantially simultaneously decoding, in a plurality of hardware threads, the at least two macro-blocks of the VP8 frame.

19. The apparatus of claim 18, integrated into at least one of a mobile phone, a set top box, a music player, a video player, an entertainment unit, a navigation device, a computer, a hand-held personal communication systems (PCS) unit, a portable data unit, and a fixed location data unit.

20. A computer program product configured for multi-threaded texture decoding, the computer program product comprising:
a non-transitory computer-readable medium having non-transitory program code recorded thereon, the program code comprising:
program code to substantially simultaneously decode at least two macro-blocks of a VP8 frame by a plurality of hardware threads, each hardware thread processing a macro-block.

21. The program product of claim 20, integrated into at least one of a mobile phone, a set top box, a music player, a video player, an entertainment unit, a navigation device, a computer, a hand-held personal communication systems (PCS) unit, a portable data unit, and a fixed location data unit.
